(19) United States
(12) Patent Application Publication
(10) Pub. No.: US 2011/0314054 A1
(43) Pub. Date: Dec. 22, 2011

(54) System and Method for a Single Session Assessment Tool

(75) Inventor: James R. Mault, Evergreen, CO (US)

(73) Assignee: MYTELEHEALTHSOLUTIONS, LLC, La Jolla, CA (US)

(21) Appl. No.: 13/163,543

(22) Filed: Jun. 17, 2011

Related U.S. Application Data
(60) Provisional application No. 61/356,448, filed on Jun. 18, 2010.
(60) Provisional application No. 61/356,452, filed on Jun. 18, 2010.
(60) Provisional application No. 61/356,456, filed on Jun. 18, 2010.
(60) Provisional application No. 61/356,509, filed on Jun. 18, 2010.

(51) Int. Cl. G06F 17/30

(52) U.S. Cl. 707/769; 707/E17.014

(57) ABSTRACT

Systems and methods for authoring and delivering single session health assessments to patients, and mapping patient information in the assessments to one or more interested parties. The method includes translating a form into an electronic form comprising a plurality of queries. The translation creates a session that is used to assess a particular health condition of the patient. Then, one or more patients are determined for targeting, wherein the patients need to respond to the electronic form. The electronic form in the form of the session is delivered to the one or more patients. A response is received to one of the plurality of queries from a patient. The response is mapped to a specific field in the database, depending on the type of response and the corresponding query. Then, the response is analyzed to determine whether the response is normal, or abnormal, or of interest to a party. When the condition is satisfied, the interested party is notified of the response, such as when the response is abnormal.

### CROSS REFERENCE TO RELATED APPLICATIONS

The present application claims priority to and the benefit of U.S. Provisional Patent Application No. 61/356,448, entitled “System and Method for Connected Health Scheduling,” filed on Jun. 18, 2010, which is herein incorporated by reference in its entirety; claims priority to and the benefit of U.S. Provisional Patent Application No. 61/356,452, filed on Jun. 18, 2010, entitled “System and Method for a Health Campaign Manager,” which is herein incorporated by reference in its entirety; claims priority to and the benefit of U.S. Provisional Patent Application No. 61/356,456, filed Jun. 18, 2010, entitled “System and Method for a Single Session Assessment Tool,” which is herein incorporated by reference in its entirety; and claims priority to and the benefit of U.S. Provisional Patent Application No. 61/356,509, filed Jun. 18, 2010, entitled “System and Method for a Records Management and Permissioning System,” which is herein incorporated by reference in its entirety. The present application is related to of U.S. patent application Ser. No. 12/899,522, entitled “System And Method For An Online Platform Distributing Condition Specific Programs Used For Monitoring The Health Of A Participant And For Offering Health Services To Participating Subscribers,” filed on Oct. 6, 2010, which is herein incorporated by reference in its entirety.

### BACKGROUND

1. Field

The medical industry welcomes new ways to provide better care for individuals and for groups of individuals. It is desirous to explore additional services that health care professionals can provide to patients.

2. The Relevant Technology

The medical industry welcomes new ways to provide better care for individuals and for groups of individuals. Part of providing better care is increasing the efficiency of various administrative aspects of health care including the intake and distribution of patient surveys. It is desirous to efficiently process patient surveys and distribute the information contained therein.

### SUMMARY

The present invention relates to the field of providing medical services. Specifically, embodiments of the present invention allows health professionals and organizations to author and provide single session health assessments tools, forms and surveys using a simple, user friendly authoring interface. That is, patients participating in health sessions provide information useful for performing health assessments on the patient. That information can be received through a communication network, analyzed to determine actions recommended to various interested parties. Notification of such actions and/or other information are delivered to the parties.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system managing a single session assessment tool, in accordance with one embodiment of the present invention.

FIG. 2 is an illustration of mapping responses to a single session health assessment in a data table, in accordance with one embodiment of the present invention.

### DETAILED DESCRIPTION

Reference will now be made in detail to embodiments of the present invention, a system and method for generating a session assessment tool capable of automating the data gathering process for one or more patients. While the invention will be described in conjunction with the described embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for systems and methods for authoring and delivering single session health assessments to patients, and mapping patient information in the assessments to one or more interested parties. As a result, embodiments of the present invention will shift the current dynamic in the market by providing health organizations a tool to automate their clinical forms and create rapid health assessments that can be broadcasted to a target user group.

### Notation and Nomenclature

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “analyzing,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### Single Session Assessment Tool

Embodiments of the present invention automate the process for delivering forms used for patient assessment. For instance, a paper form is used for various purposes when interacting with a patient. In one case, the patient fills out a new patient form. In other cases, the patient fills out an admission form, or a general health assessment form. In all of these cases, the form is used with a singular purpose. That is, once the form is filled out by the patient, the health care professional takes a look at the form and makes a quick assessment of the patient based on responses in the form. The form typically is then placed in a file without further interaction or use.

On the other hand, embodiments of the present invention are able to automate the information gathering process, and to perform additional actions based on the information. Specifically, the collected information may be analyzed, and notification of results of the analysis delivered not only to the originally intended health care professional requesting the original assessment, but also to any interested health care professional that has an interest in specific pieces of information, or the condition of the patient.

An example used throughout this Application is the pre-admission process. Generally, when a patient is scheduled for surgery on a particular date, the medical staff contacts the patient the day before surgery to perform a pre-admission process. Typically, the outpatient admitting department uses a paper form, and calls each patient on the phone to perform the pre-admission process. Questions are asked of the patient, to assess the health of the patient, and to prepare the surgical team for surgery. For instance, one question may determine whether the patient is allergic to anesthesia.

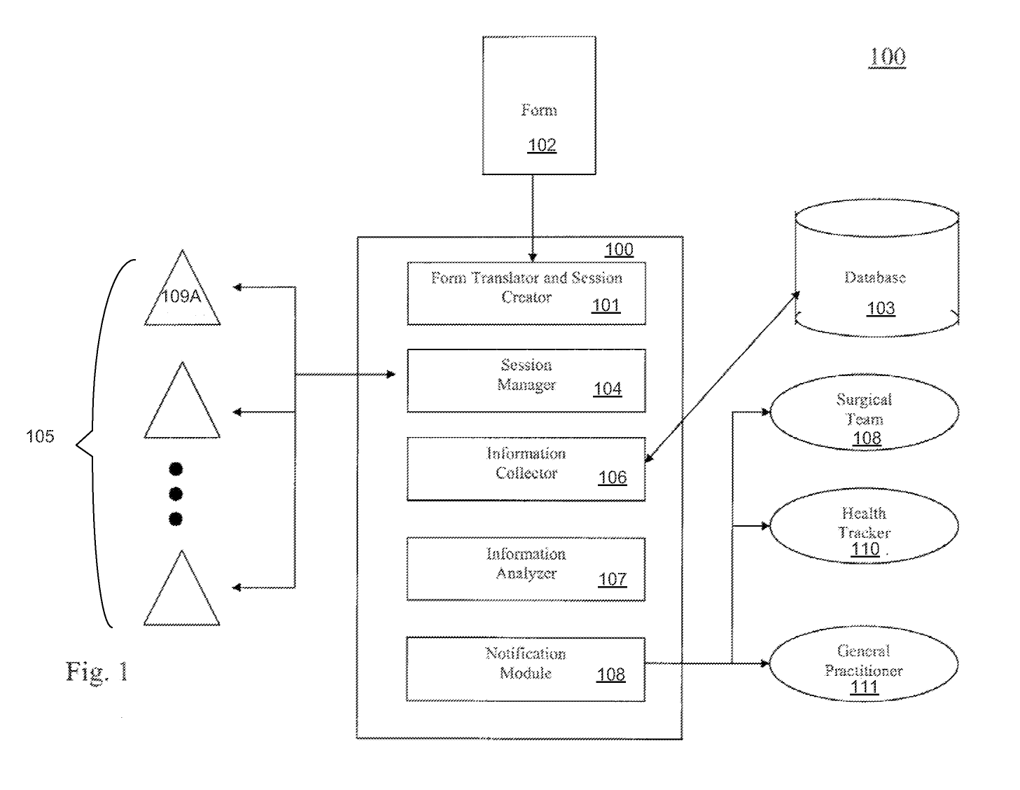

FIG. 1 is a diagram illustrating a single session assessment tool and system 100 that is capable of authoring and delivering a single session health assessments to patients, in accordance with one embodiment of the present invention. In addition, the single session assessment tool and system 100 is capable of implementing a method for analyzing responses to a single session health assessment for purposes of assessing the health of a patient. As such, the single session assessment tool and system 100 is capable of automating the data collection and analysis process, and to notify interested parties of information collected.

In embodiments of the present invention, a health care provider may take advantage of the automatic performance of making health assessments. For instance, a health care provider may be a medical doctor, doctor group, laboratory, hospital, etc. that needs to assess the health of a patient. In addition, the health care provider has need to assess a large number of patients, and in many cases for patients in similar circumstances. Embodiments of the present invention are capable of efficiently processing information in order to make health assessments for the large number of patients. The greater the number of patients, the better the performance of the system, when compared to traditional paper recordation and analysis.

As shown in FIG. 1, the single session assessment tool and system 100 includes a form translator and session creator 101 that receives a form 102. The form 102 may be in any format, including a paper form typically found in medical environments. The form translator and session creator 101 translates the form 102 into an electronic form, comprising a plurality of queries. In particular, the form 102 is re-created into a normalized electronic form so that it is accessible over a communication network, such as the internet. The queries are used to assess the particular health of the patient. In addition, the queries in the form 102 and now translated into the electronic form are associated with fields in a database 103, for purposes of identification and access. As a result, the form translator and session creator 101 creates a session for assessing the health of the patient, based on the queries in the electronic form.

As described previously, one form 102 may assist health care professionals in preparing for surgery on a patient. The queries in the form 102 may assist the surgical team in preparing for the surgical procedure.

The single session assessment tool also includes a session manager 104 for delivering the electronic form to one or more patients 105. One benefit of the single session assessment tool and system 100 is that a plurality of patients 105 may be batched together, wherein the patients 105 have need to respond to questions in the single session for assessing the health of the patient. For instance, in the case of performing pre-admission assessments, the health care provider may upload a file with a list of patients 105 that are undergoing surgery the next day and that need pre-admission assessments performed. As such, once all the patients 105 are determined, the session manager 104 is able to deliver the session to the plurality of patients 105 in batch form as shown in FIG. 1, rather than one at a time. In particular, the health care provider may create a custom message inviting patients 105 on the list to respond to the delivered session.

In one embodiment, the assessment tool is implemented through a communication system, such as the internet. For instance, the single session assessment tool and system 100 communicates with patients 105 through the network in order to deliver the session and to receive responses and inputs in relation to the session.

The single session assessment tool and system 100 also includes an information collector 106 for receiving from a patient 105A a response to one of a plurality of queries in the session. That is, the information collector 106 also interfaces with the patient 105A as the patient 105A is completing the session. In that manner, the single session assessment tool and system 100 is able to collect relevant information providing a window into the health of the patient 105A. As shown, responses are stored in the database 103. Though the session manager single session assessment tool and system 100 is configured to receive and process multiple responses from one or more patients 105, for purposes of illustration, receipt of one response is used to illustrate the general process implemented by the single session assessment tool and system 100.

The single session assessment tool and system 100 so includes an information analyzer 107 that determines when the response is normal, abnormal, or is of general interest. Other categories of responses are contemplated. As such the single session assessment tool and system 100 is able to flag information that is of interest to one or more parties, or indicates when the health of the patient 105A is poor. For instance, in the example provided above, when the patient 105A indicates that he or she has an allergic reaction to anesthesia, this information is important and may affect how the surgical team 108 prepares for the surgery. As a result, the response to the question on allergic reactions to anesthesia is analyzed with care by the single session assessment tool and system 100. Since it is automatically performed by the single session assessment tool and system 100, there is less chance of a response indicating that the patient 105A is allergic to anesthesia will be missed. As such, the single session assessment tool and system 100 is able to determine whether the patient 105 is allergic to anesthesia.

The single session assessment tool and system 100 also includes a notification module 109 for notifying an interested party of the response when the response is abnormal, or is of interest to that party. As shown, interested parties may include the surgical team 108, a health tracking department 110, a general practitioner 111, and other entities that may be interested in the health of the patient 105A.

In still another embodiment, the alerts may be communicated to the member health care provider via any communication means suitable for relaying the urgency of the situation. For instance, an email message, text message, page, etc. may be generated and delivered to the appropriate parties.

In one implementation, the response is analyzed and triggers a response when the response is abnormal. For instance, when it is determined that the patient is allergic to anesthesia, the single session assessment tool and system 100 is able to provide notification to the surgical team 108 of the patient's 105A condition. As a result, the surgical team 108 may modify its procedure in reaction to the notification. The surgical team 108 may add another nurse to provide further assistance when the patient 105A is under anesthesia.

In addition, depending on the response to a question, the single session assessment tool and system 100 is able to determine when that response triggers an additional alert or notification. As such, patient responses can trigger specific alerts and notifications based upon what information is entered, in what order, and in what context, etc.

In a further development, this automatic triggering may transform the session into an automated triaging tool, in accordance with one embodiment of the present invention. That is, responses may help determine the order in which patients receive care. These responses may be displayed in a triage dashboard.

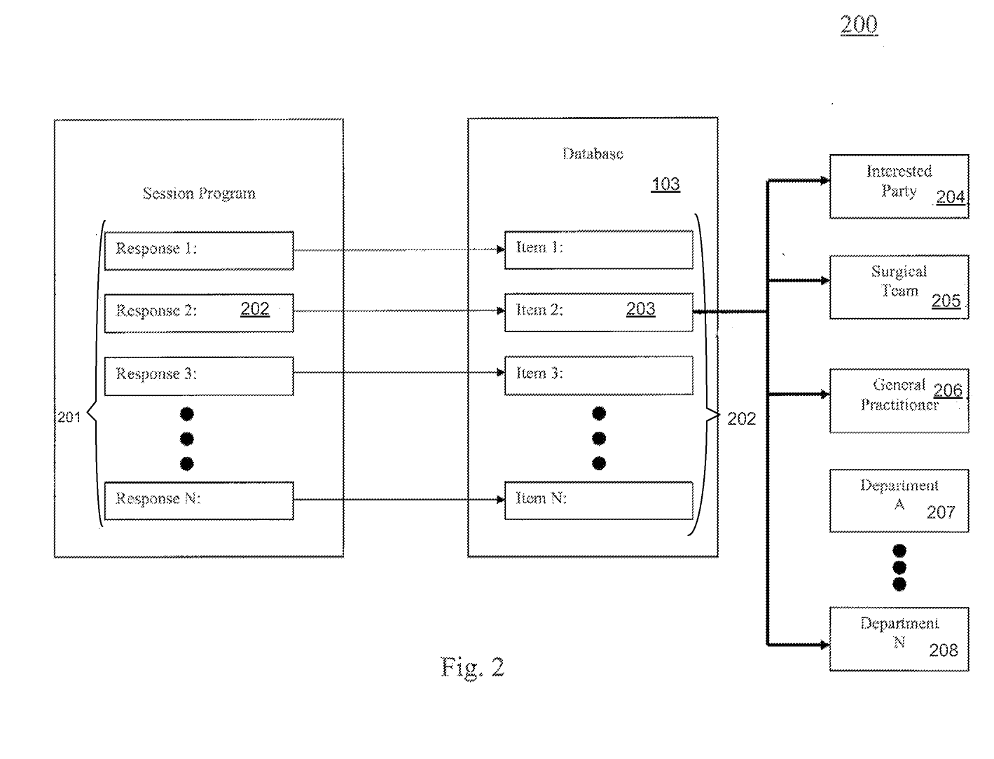

FIG. 2 is an illustration of mapping responses from a session assessing the health of a patient into a data table, in accordance with one embodiment of the present invention.

An innovative feature of the assessment tool is the ability to map each specific field of the single session assessment and the corresponding responses from patients to a specific item in the database 103. The direct data mapping capability makes it possible for a health organization or health care provider to take an offline (e.g., paper) form 102, turn it in to an electronic form, interface with the patient 105 as the patient 105 fills out the form through a communication network, and have the information collected from the patient 105 inputted as items in the database 103. The items are determined from patient responses, and can be immediately leveraged by other features of the system to include health trackers, a triage dashboard, and medication tools.

As shown in FIG. 2, a response 201 is entered as a corresponding item 202 depending on the type of response and the corresponding query. One item may be for a positive response, and another item may be for a negative response to a corresponding query. The item may trigger an alert or notification to an interested party 208, as previously described. For instance, in the example of providing a pre-admission session, response 2 202 is inputted into item 2 203. An entry into item 2 triggers notifications and alerts to various parties, to include an interested party 204, the surgical team 205, general practitioner 206, and department A 207 through department N 208. All of these parties are interested in the information contained in item 2 202, for one reason or another. For example, the surgical team 205 may be interested in learning that the patient 105 is allergic to anesthesia. The general practitioner 206 may also want to be notified of such condition. Also, other interested parties 204 and department N 208 may also be interested in that information.

In one embodiment, some of the interested parties may be of a different organization than the original entity (e.g., surgical team 205) asking for responses to the session. In this case, permissions by the patient 105 may allow for information collected to also be delivered to other interested parties. For instance, information relating to an allergic reaction to anesthesia may be alerted to a dental surgeon that is on a health care team of the patient 105. In that manner, the dental surgeon knows that the patient 105 needs extra care when administering anesthesia.

Systems and methods for authoring and delivering single session health assessments to patients, and mapping patient information in the assessments to one or more interested parties is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A computer implemented method for providing session assessments to a health care provider, the computer implemented method comprising:
accessing a computer system having a database, a communication interface, and a processor;
inputting a form at said computer system;
causing said computer system to translate said form into an electronic form having a plurality of queries;
causing said computer system to determine one or more patients to send said electronic form to;
causing said computer system to deliver said electronic form to said one or more patients;
receiving at said computer system data as a response to one of said plurality of queries;
causing said computer system to map said data to a field in said database;
causing said computer system to analyze said data to determine that said response is abnormal; and
causing said computer system to provide a notification of said response.

2. The computer implemented method of claim 1, the method further comprising:
receiving at said computer system information correlating an interested party with an interested field in said database;
causing said computer system to provide a notification to said interested party when said data is inputted into said interested field.

3. The computer implemented method of claim 1, wherein said form is a paper based form.

4. The computer implemented method of claim 1, comprising:
receiving a set of permissions from a patient, said permissions set of permissions identifying interested parties allowed to access said data.

5. The computer implemented method of claim 4, comprising:
causing said computer system to allow access to said data only to interested parties identified by said set of permissions.

6. The computer implemented method of claim 4, comprising:
causing said computer system to deny access to said data to interested parties identified in said set of permissions.

7. A computer program product for providing session assessments to a health care provider, comprising a computer readable storage media having computer executable instructions stored thereon that, when executed by a computer processor of a computer system cause the computer system to implement a method, the method comprising:
in response to receiving a form at said computer system, translating said form into an electronic form having a plurality of queries;
determining one or more patients to send said electronic form to;
delivering said electronic form to said one or more patients;
in response to receiving data as a response to one of said plurality of queries, causing said computer system to map said data to a field in a database;
analyzing said data to determine that said response is abnormal; and
providing a notification of said response.

8. The computer program product of claim 7, said method further comprising:
in response to receiving information correlating an interested party with an interested field in said database, providing a notification to said interested party.

9. The computer program product of claim 7, wherein said form is a paper based form.

10. The computer program product of claim 7, wherein said method further comprises:
in response to receiving a set of permissions from a patient, said set of permissions identifying interested parties allowed to access said data, allowing access to said data only said to interested parties identified by said set of permissions.

11. The computer program product of claim 7, wherein said method further comprises:
in response to receiving a set of permissions from a patient, said set of permissions identifying interested parties allowed to access said data, denying access to said data to said interested parties identified in said set of permissions.

12. A computer system for providing session assessments, the computer system comprising:
a session creator configured to translate a form into an electronic form comprising a plurality of queries, wherein said session creator creates a session for assessing the health of a patient based on said electronic form;
a session manager configured to deliver said electronic form to one or more patients;
an information collector configured to receive a response to one of said plurality of queries from a patient;
an information analyzer configured to determine when said response is abnormal; and
a notification module configured to notify an interested party of said response when abnormal.

13. The computer system of claim 12, further comprising a database, said database configured to store said responses from said patients.

14. The computer system of claim 12, further comprising a network communication component configured to communicate with other computer systems over a network.

15. The computer system of claim 12, wherein notifications are delivered over a network.

16. The computer system of claim 12, wherein said electronic form is delivered by electronic messaging.

17. The computer system of claim 12, wherein said electronic form is published to a web site and one or more of said patients access said website to respond to at least one of said plurality of queries.
